(19) United States
(12) Patent Application Publication
(10) Pub. No.: US 2025/0357684 A1
(43) Pub. Date: Nov. 20, 2025

(54) TERMINAL BLOCK

(71) Applicant: Yazaki Corporation, Tokyo (JP)

(72) Inventors: Yasuhiro TANAKA, Shizuoka (JP); Yasuhiro OTSUTA, Shizuoka (JP); Yusuke TSUTAGAWA, Shizuoka (JP); Masatoshi YAMADA, Shizuoka (JP); Shinya TACHIBANA, Shizuoka (JP); Katsuya NAKANO, Shizuoka (JP); Sota ARAI, Shizuoka (JP)

(73) Assignee: Yazaki Corporation, Tokyo (JP)

(21) Appl. No.: 19/188,341

(22) Filed: Apr. 24, 2025

(30) Foreign Application Priority Data
May 20, 2024 (JP) 2024-081700

(51) Int. Cl. H01R 9/22; H01R 9/24

(52) U.S. Cl. CPC H01R 9/223; H01R 9/24

(57) ABSTRACT

A terminal block includes a bus bar, a housing, and an annular seal member that is assembled to one end face and performs water stop between the housing and an attachment target object. On the one end face, an annular recess that is recessed toward a side opposite to the attachment target object and houses the seal member is provided. The seal member is formed in a tapered shape in which an end face facing a side surface of the recess is inclined to be gradually separated from the side surface toward a bottom surface side of the recess in an axial direction and is configured such that a gap between the end face and the side surface gradually increases toward the bottom surface side.

### CROSS-REFERENCE TO RELATED APPLICATION(S)

The present application claims priority to and incorporates by reference the entire contents of Japanese Patent Application No. 2024-081700 filed in Japan on May 20, 2024.

### BACKGROUND OF THE INVENTION

### 1. Field of the Invention

The present invention relates to a terminal block.

### 2. Description of the Related Art

As a technique relating to a terminal block of a related art, for example, JP 2023-171 078 A discloses a terminal block including a bus bar, a housing that holds the bus bar, and an annular seal member that is assembled to one end face in an axial direction of the housing and performs water stop between the housing and an attachment target object. An annular recess that is recessed toward a side opposite to the attachment target object in the axial direction and houses the seal member is provided on one end face of the housing.

Incidentally, in the terminal block described in JP 2023-171 078 A described above, there is room for further improvement in ensuring both of assemblability of the seal member to the housing and a water stop property.

### SUMMARY OF THE INVENTION

The present invention has been made in view of the above circumstances, and an object of the present invention is to provide a terminal block that can ensure both of assemblability of a seal member to a housing and a water stop property.

In order to achieve the above mentioned object, a terminal block according to one aspect of the present invention includes a bus bar extending in an axial direction; a housing that holds the bus bar; and an annular seal member that is assembled to one end face of the housing in the axial direction and performs water stop between the housing and an attachment target object, wherein on the one end face of the housing, an annular recess that is recessed toward a side opposite to the attachment target object in the axial direction and houses the seal member is provided, and the seal member is formed in a tapered shape in which an end face facing a side surface of the recess is inclined to be gradually separated from the side surface toward a bottom surface side of the recess in the axial direction and is configured such that a gap between the end face and the side surface gradually increases toward the bottom surface side in a free state in which the seal member is not compressed between the housing and the attachment target object.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a terminal block according to an embodiment;

FIG. 2 is an exemplary exploded perspective view of the terminal block according to the embodiment;

FIG. 3 is an exemplary cross-sectional view of the terminal block according to the embodiment;

FIG. 4 is an exemplary plan view of the terminal block according to the embodiment; and

FIG. 5 is an exemplary cross-sectional view of the terminal block according to the embodiment and is an enlarged view of the vicinity of a seal member.

### DETAILED DESCRIPTION OF THE PREFERRED EMBODIMENTS

An embodiment according to the present invention is explained in detail below with reference to the drawings. Note that the present invention is not limited by the embodiment explained below. Components in the embodiment explained below include components that can be easily substituted by those skilled in the art of components that are substantially the same. In the present specification, ordinal numbers are used only to distinguish components, members, parts, positions, directions, and the like and do not indicate order and priority.

### EMBODIMENT

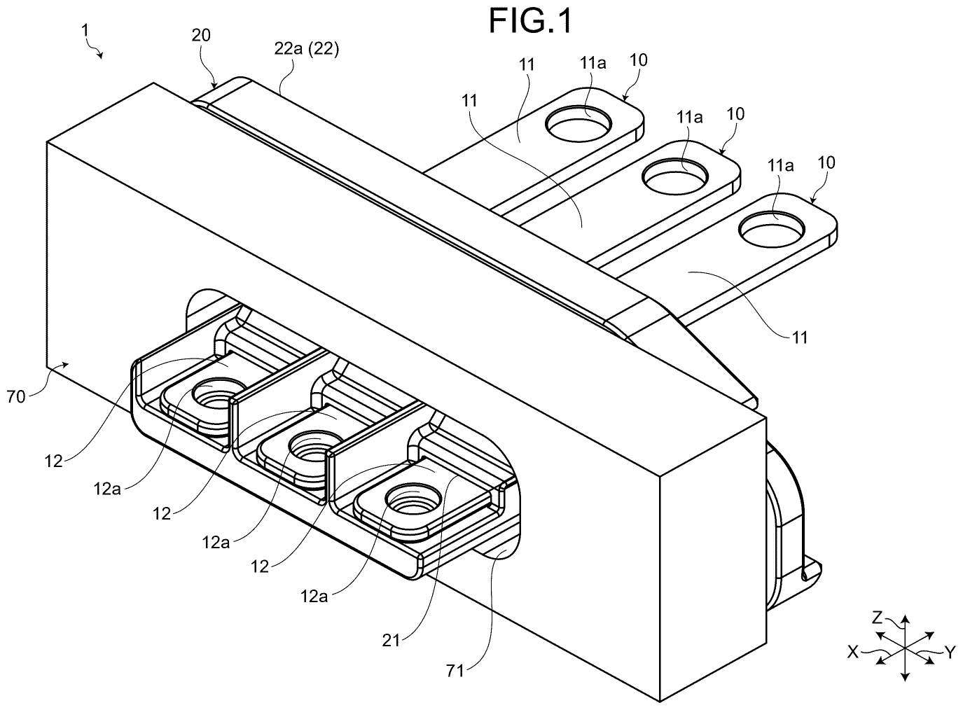

FIG. 1 is a perspective view of a terminal block 1 according to an embodiment. The terminal block 1 in the present embodiment illustrated in FIG. 1 is mounted on a vehicle such as an electric car or a hybrid car, is attached to an attachment target object 70, and relays electrical connection between a not-illustrated first device and a not-illustrated second device. The terminal block 1 in the present embodiment includes a plurality of bus bars 10. An external terminal of the first device is electrically connected to a first connecting portion 11 provided at one end portion of the plurality of bus bars 10. In the terminal block 1 in the present embodiment, an external terminal of the second device is electrically connected to a second connecting portion 12 provided at the other end portion of the plurality of bus bars 10. The first device is, for example, one of a motor and an inverter and the second device is, for example, the other of the motor and the inverter. Note that the terminal block 1 is not limited to this example and may be used for, for example, relaying the first device or the second device and a routing material and relaying a routing material and a routing material.

In the following explanation, among a first direction, a second direction, and a third direction intersecting one another, the first direction is referred to as “axial direction X”, the second direction is referred to as “width direction Y”, and the third direction is referred to as “fastening direction Z”. Here, the axial direction X, the width direction Y, and the fastening direction Z are substantially orthogonal to each other. The axial direction X is typically equivalent to an extending direction of the plurality of bus bars 10, an insertion direction of the plurality of bus bars 10 into a housing 20, the depth direction (the front-rear direction) of the terminal block 1, and the like. The width direction Y is typically equivalent to the width direction of the plurality of bus bars 10, the width direction (the left-right direction) of the terminal block 1, and the like. The fastening direction Z is typically equivalent to the thickness direction of the plurality of bus bars 10, a fastening direction of the plurality of bus bars 10 and an external terminal, the height direction (the vertical direction) of the terminal block 1, and the like. The directions used in the following explanation are explained as directions in a state in which the terminal block 1 is attached to the attachment target object 70 unless particularly noted otherwise.

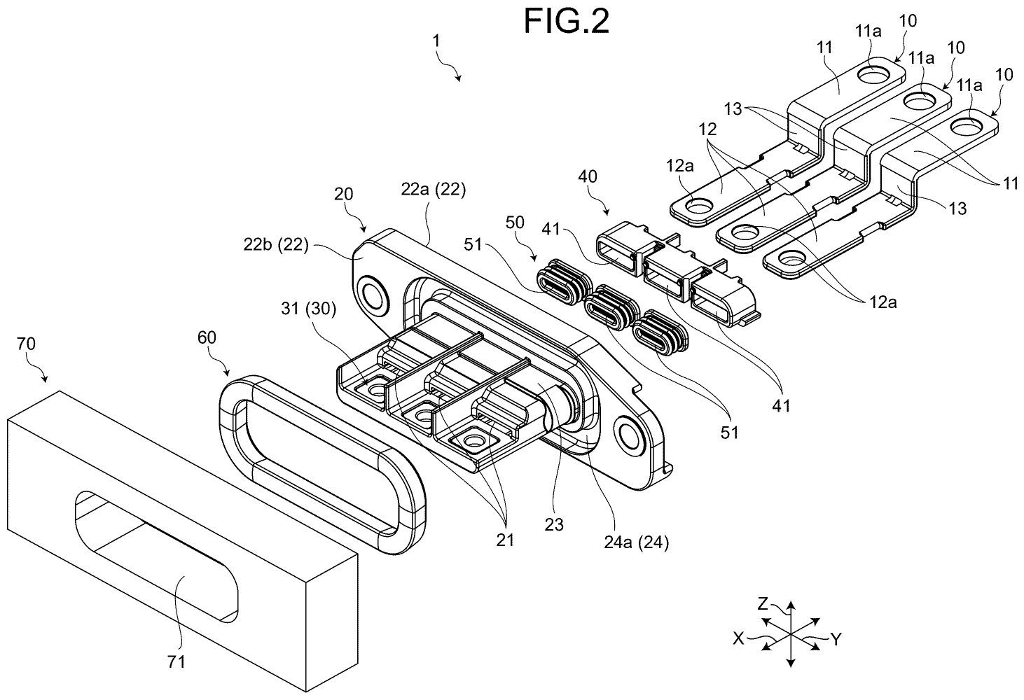

FIG. 2 is an exploded perspective view of the terminal block 1. As illustrated in FIG. 2, the terminal block 1 includes, for example, the bus bar 10, the housing 20, a fastening member 30, a packing holder 40, a packing 50, and a seal member 60. The bus bar 10 is a terminal metal fitting made of a conductive metal material and is electrically connected to the external terminal explained above. In the present embodiment, in the terminal block 1, three bus bars 10 are provided side by side in the width direction Y. The number of the bus bars 10 is not limited to this example. For example, one, two, or four or more bus bars 10 may be provided.

The bus bar 10 includes, for example, a first connecting portion 11 provided at one end portion in the axial direction X, a second connecting portion 12 provided at the other end portion in the axial direction X, and an intermediate portion 13 provided between the first connecting portion 11 and the second connecting portion 12. The first connecting portion 11, the second connecting portion 12, and the intermediate portion 13 are integrally formed of a conductive metal material. That is, in the bus bar 10, by applying various kinds of machining such as bending to one sheet metal according to shapes corresponding to the first connecting portion 11, the second connecting portion 12, and the intermediate portion 13, the sections are three-dimensionally integrally formed in a crank shape.

The first connecting portion 11 is a portion electrically and mechanically connected to the external terminal of the first device explained above. The first connecting portion 11 extends in the axial direction X. In the first connecting portion 11, an attachment hole 11a to which a fastening member such as a bolt that fastens the bus bar 10 and the external terminal is attached is provided. The attachment hole 11a is a through hole piercing through the first connecting portion 11 in the fastening direction Z and is configured as, for example, a round hole having substantially the same diameter as a shaft portion of the fastening member.

The second connecting portion 12 is a section electrically and mechanically connected to the external terminal of the second device explained above. The second connecting portion 12 extends in the axial direction X and is positioned to be shifted to the other end portion side in the axial direction X and in the fastening direction Z with respect to the first connecting portion 11. In the second connecting portion 12, an attachment hole 12a to which a bolt or the like of the fastening member 30 that fastens the bus bar 10 and the external terminal is attached is provided. The attachment hole 12a is a through hole piercing through the second connecting portion 12 in the fastening direction Z and is configured as, for example, a round hole having substantially the same diameter as a shaft portion of the bolt.

The intermediate portion 13 is a portion connected between the first connecting portion 11 and the second connecting portion 12. The intermediate portion 13 includes a planar portion extending in the fastening direction Z and forms a step between the first connecting portion 11 and the second connecting portion 12. The intermediate portion 13 is formed to be bent, for example, at an angle of 90° with respect to the first connecting portion 11 and the second connecting portion 12. That is, in the present embodiment, substantially the entire intermediate portion 13 is configured as a planar section extending in the fastening direction Z. The thickness direction of the intermediate portion 13 is in the axial direction X intersecting the thickness direction of the first connecting portion 11 and the second connecting portion 12.

The housing 20 holds the second connecting portions 12 of the three bus bars 10 disposed side by side in the width direction Y and is formed of an insulating synthetic resin material or the like. The housing 20 includes, for example, a housing main body 22 and a housing protruding portion 23 protruding from the housing main body 22 to a side opposite to the bus bar 10 in the axial direction X. In the housing 20, the housing main body 22 and the housing protruding portion 23 are integrally formed.

An insertion hole 21 into which the second connecting portion 12 of the bus bar 10 is inserted in the axial direction X is provided on the inside of the housing main body 22 and the housing protruding portion 23. The insertion hole 21 is an opening (an insertion space portion) piercing through the housing main body 22 and the housing protruding portion 23 in the axial direction X. In the present embodiment, in the housing 20, three insertion holes 21 are provided to correspond to the bus bars 10. These three insertion holes 21 are partitioned from one another in the width direction Y.

The housing main body 22 includes the other end face 22a in the axial direction X facing the bus bar 10 side and one end face 22b in the axial direction X facing the seal member 60 side. The other end face 22a is a portion facing the intermediate portion 13 of the bus bar 10 in the axial direction X in the peripheral edge portion of the insertion hole 21. The one end face 22b is a portion in which a recess 24 that holds the seal member 60 is provided in the peripheral edge portion of the housing protruding portion 23. The recess 24 is recessed from the one end face 22b toward the side opposite to the attachment target object 70 in the axial direction X and houses the seal member 60. The recess 24 is formed in, for example, a substantially elliptical annular shape along the external shape of the seal member 60.

The seal member 60 prevent foreign matters such as moisture from entering the inside of the terminal block 1 from an annular gap between the housing 20 and the attachment target object 70 explained above. The seal member 60 is formed of an elastically deformable member such as rubber or resin. The seal member 60 is formed in, for example, a substantially elliptical tubular shape and is inserted into the recess 24 explained above. The seal member 60 is interposed between a bottom surface 24a of the recess 24 and the end face of the attachment target object 70 on the housing main body 22 side in a state in which the terminal block 1 is attached to the attachment target object 70. Note that, in the attachment target object 70, a through hole 71 through which the housing protruding portion 23 is inserted in the axial direction X is provided.

The fastening member 30 fastens the bus bar 10 and the external terminal to the housing 20 in the fastening direction Z. The fastening member 30 includes, for example, a not-illustrated bolt and a nut 31. The bolt includes a shaft portion in which a male screw portion to be meshed with a female screw portion of the nut 31 is provided, a head portion having a larger diameter than the shaft portion, and a flange portion (a washer) interposed between the head portion and the external terminal. For example, the nut 31 is attached and fixed to the distal end portion of the housing protruding portion 23 in a state in which rotation is restricted. The nut 31 is aligned with the attachment hole 12a in the fastening direction Z according to the insertion of the second connecting portion 12 into the insertion hole 21. In a state in which the second connecting portion 12 and the external terminal are sandwiched between the head and the nut 31, the bolt of the fastening member 30 is fastened to the nut 31 with the shaft portion piercing through the second connecting portion 12 and the external terminal in the fastening direction Z.

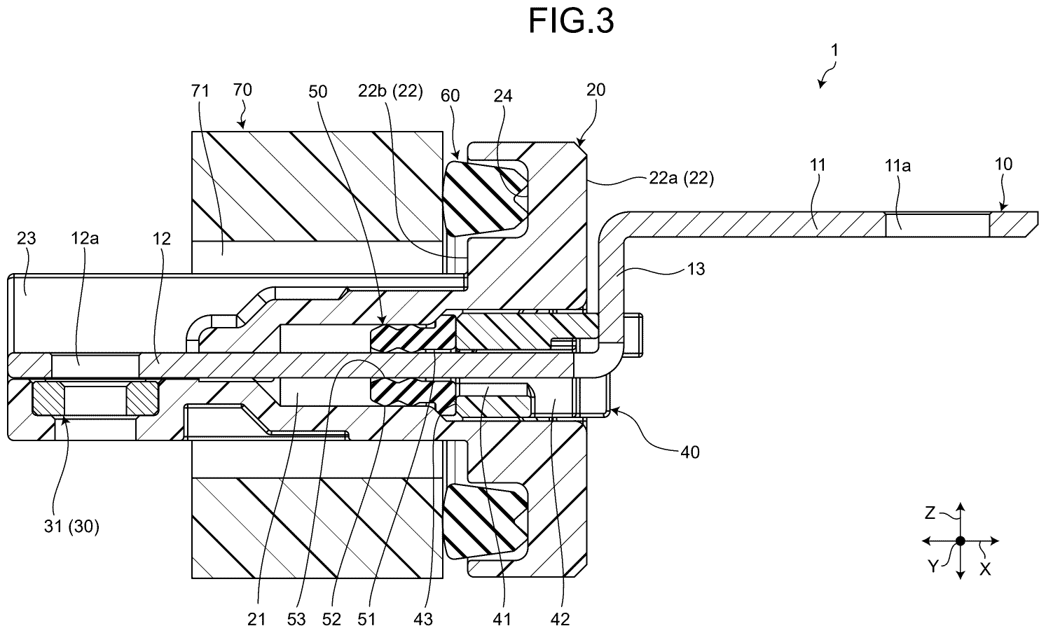

FIG. 3 is a cross-sectional view of the terminal block 1. As illustrated in FIGS. 2 and 3, the packing 50 includes, for example, an insertion hole 51 through which the second connecting portion 12 of the bus bar 10 is inserted in the axial direction X and seals the periphery of the second connecting portion 12 inserted through the insertion hole 51. In the present embodiment, in the terminal block 1, three packings 50 are provided to correspond to the bus bars 10. The packings 50 are formed of, for example, an elastically deformable member such as rubber. The packings 50 are also referred to as terminal packing, rubber plug, bush, or the like.

In each of the packings 50, a plurality of outer circumference side lip portions 52 and a plurality of inner circumference side lip portions 53 are provided. The outer circumference side lip portions 52 are pleated water stop portions formed in a substantially annular shape along the outer circumferential surfaces of the packings 50. In the present embodiment, in each of the packings 50, two outer circumference side lip portions 52 are provided side by side in the axial direction X. In a state in which the packings 50 are attached in the insertion hole 21 of the housing 20, the outer circumference side lip portions 52 come into contact with the inner surface of the insertion hole 21 and stop water between the outer circumference side lip portions 52 and the inner surface. The outer circumference side lip portions 52 are configured to adhere the inner surface of the insertion hole 21 with elastic deformation and seal an annular space between the inner surface and the outer circumferential surfaces of the packings 50.

The inner circumference side lip portions 53 are pleated water stop portions formed in a substantially annular shape along the inner circumferential surfaces of the packings 50. In the present embodiment, in each of the packings 50, two inner circumference side lip portions 53 are provided side by side in the axial direction X. In a state in which the second connecting portion 12 of the bus bar 10 is inserted (press-fit) in the insertion hole 51 of the packing 50, the inner circumference side lip portions 53 come into contact with the outer surface of the second connecting portion 12 and stops water between the inner circumference side lip portions 53 and the outer surface of the second connecting portion 12. The inner circumference side lip portions 53 are configured to adhere the outer surface of the second connecting portion 12 with elastic deformation and seal an annular space between the outer surface and the inner circumferential surface of the packing 50.

The packing holder 40 includes, for example, a bus bar insertion portion 41 through which the second connecting portion 12 of the bus bar 10 is inserted in the axial direction X, supports the periphery of the second connecting portion 12 inserted through the bus bar insertion portion 41, and supports the packing 50 in the axial direction X. In the present embodiment, in the packing holder 40, three bus bar insertion portions 41 are provided to correspond to the bus bars 10. The three bus bar insertion portions 41 are, for example, partitioned from one another in the width direction Y via a partition wall 42 provided between two bus bar insertion portions 41 adjacent to each other in the width direction Y. The packing holder 40 is formed of, for example, an insulating synthetic resin material.

The packing holder 40 includes, for example, an end face 43 facing the packing 50. The end face 43 is a portion that supports the packing 50 in the axial direction X. In the present embodiment, the packing holder 40 is inserted into the insertion hole 21 of the housing 20 in a state in which the second connecting portion 12 is inserted through the bus bar insertion portion 41 and the end face 43 is in contact with the packing 50. The packing holder 40 functions as a portion that pushes the packing 50 toward the depth side of the insertion hole 21 at the time of assembly to the insertion hole 21.

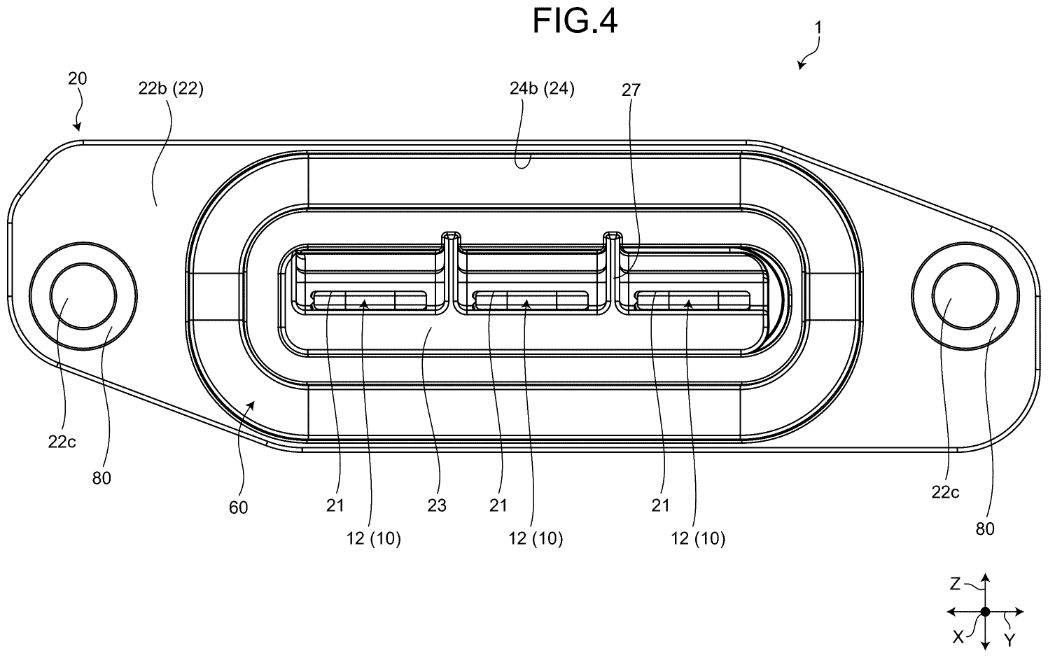

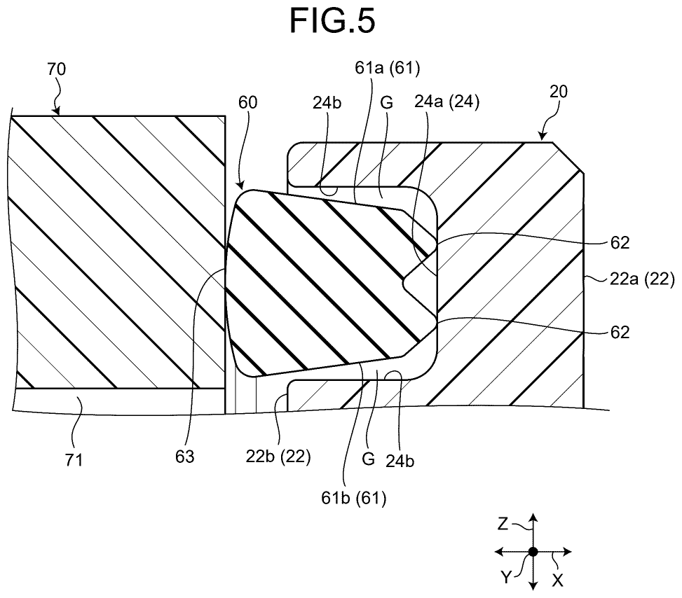

FIG. 4 is a plan view of the terminal block 1 and FIG. 5 is a cross-sectional view of the terminal block 1 and is an enlarged view of the vicinity of the seal member 60. As illustrated in FIGS. 4 and 5, in the present embodiment, attachment holes 22c to which fastening members such as bolts that fasten the housing 20 and the attachment target object 70 are attached are provided at both end portions of the housing main body 22 in the width direction Y. The attachment holes 22c are through holes piercing through the housing main body 22 in the axial direction X. Shaft portions of the bolts are inserted therethrough the attachment holes 22c. Collar members 80 that suppress interference between the shaft portions of the bolts and the inner surfaces of the attachment holes 22c are provided on the inner side of the attachment holes 22c.

For example, the seal member 60 is compressed in the axial direction X according to the fastening of the housing 20 and the attachment target object 70 via the bolts. Accordingly, an elastic restoring force is generated in the seal member 60, a surface pressure between the attachment target object 70 (see FIG. 5) and the seal member 60 and a surface pressure between the housing 20 and the seal member 60 are increased and the sealability at these positions is improved. In FIG. 5, a free state in which the seal member 60 is not compressed between the housing 20 and the attachment target object 70 is illustrated. In a compressed state (an attached state), the seal member 60 adheres to the attachment target object 70 over substantially the entire region of a contact surface 63 on the attachment target object 70 side in the axial direction X and adheres to the bottom surface 24a of the recess 24 such that a plurality of lip portions 62 on the housing 20 side are crushed in the axial direction X.

Here, in the present embodiment, the seal member 60 is formed in a tapered shape in which an end face 61 facing a side surface 24b of the recess 24 is inclined to be gradually separated from the side surface 24b toward the bottom surface 24a side of the recess 24 in the axial direction X. Specifically, in the present embodiment, the seal member 60 is formed in a tapered shape in which each of an outer side end face 61a and an inner side end face 61b of the end face 61 is inclined to be gradually separated from the side surface 24b toward the bottom surface 24a side of the recess 24 and has a substantially trapezoidal cross-sectional shape. The outer side end face 61a is an end face 61 facing the side surface 24b on the annular outer circumference side of the recess 24 and the inner side end face 61b is an end face 61 facing the side surface 24b on the annular inner circumference side of the recess 24. The outer side end face 61a is also referred to as outer circumferential surface or the like and the inner side end face 61b is also referred to as inner circumferential surface or the like.

The seal member 60 is configured such that, in a free state in which the seal member 60 is not compressed between the housing 20 and the attachment target object 70, each of a gap G between the outer side end face 61a and the side surface 24b on the annular outer circumference side and the gap G between the inner side end face 61b and the side surface 24b on the annular inner circumference side gradually increases toward the bottom surface 24a side of the recess 24. That is, in the present embodiment, the recess 24 is formed in a flat shape in which each of the side surface 24b on the annular outer circumference side and the side surface 24b on the annular inner circumference side extends in the axial direction X, and the outer side end face 61a and the inner side end face 61b are inclined toward the sides approaching each other in the fastening direction Z toward the bottom surface 24a side of the recess 24 with respect to the pair of side surfaces 24b. As a result, the insertability of the housing 20 into the recess 24 is enhanced while a contact area of the contact surface 63 of the seal member 60 with the attachment target object 70 being ensured.

In the seal member 60, the plurality of lip portions 62 are provided. The lip portion 62 is a pleated water stop portion formed in a substantially annular shape along a surface on a side opposite to the contact surface 63 in the axial direction X of the seal member 60. In the present embodiment, in the seal member 60, two lip portions 62 are provided side by side in the fastening direction Z. The lip portion 62 comes into contact with the bottom surface 24a of the recess 24 and stops water between the bottom surface 24a and the lip portion 62 in a state in which the seal member 60 is attached in the recess 24 of the housing 20. The lip portion 62 is configured to adhere to the bottom surface 24a of the recess 24 with elastic deformation and seal an annular space between the bottom surface 24a and a surface of the seal member 60 on a side opposite to the contact surface 63. This prevents foreign matters such as moisture from entering the gap G between the inner side end face 61b and the side surface 24b on the annular inner circumference side from the gap G between the outer side end face 61a and the side surface 24b on the annular outer circumference side.

As explained above, in the terminal block 1 in the present embodiment, the seal member 60 is formed in a tapered shape in which the end face 61 facing the side surface 24b of the recess 24 is inclined to be gradually separated from the side surface 24b toward the bottom surface 24a side of the recess 24 in the axial direction X and is configured such that the gap G between the end face 61 and the side surface 24b gradually increases toward the bottom surface 24a side in a free state in which the seal member 60 is not compressed between the housing 20 and the attachment target object 70. With this configuration, in the terminal block 1, for example, while the contact area of the contact surface 63 with the attachment target object 70 can be ensured by the seal member 60 having the tapered shape, assemblability (insertability) of the housing 20 to the recess 24 can be improved. As a result, the terminal block 1 can ensure both of the assemblability of the seal member 60 to the housing 20 and the water stop property.

In the terminal block 1 according to the present embodiment, the end face 61 includes the outer side end face 61a facing the side surface 24b on the annular outer circumference side of the recess 24 and the inner side end face 61b facing the side surface 24b on the annular inner circumference side of the recess 24. The seal member 60 is formed in a tapered shape in which each of the outer side end face 61a and the inner side end face 61b are inclined to be gradually separated from the side surface 24b toward the bottom surface 24a side in the axial direction X and is configured such that, in a free state in which the seal member 60 is not compressed between the housing 20 and the attachment target object 70, each of the gap G between the outer side end face 61a and the side surface 24b and the gap G between the inner side end face 61b and the side surface 24b gradually increases toward the bottom surface 24a side. With this configuration, in the terminal block 1, for example, the assemblability (insertability) of the housing 20 to the recess 24 can be further improved compared with when one of the outer side end face 61a and the inner side end face 61b is formed in a flat surface shape along the side surface 24b.

In the present embodiment, the case in which both of the outer side end face 61a and the inner side end face 61b are formed in the tapered shape inclined with respect to the side surface 24b is exemplified. However, without being limited to this example, for example, only one of the outer side end face 61a and the inner side end face 61b may be formed in the tapered shape inclined with respect to the side surface 24b.

Although the embodiment of the present invention is exemplified above, the embodiment explained above is merely an example and is not intended to limit the scope of the invention. The embodiment explained above can be implemented in various other forms, and various omissions, substitutions, combinations, and changes can be made without departing from the gist of the invention. Specifications (structure, type, direction, form, size, length, width, thickness, height, number, arrangement, position, material, and the like) of the components, the shapes, and the like can be changed as appropriate and implemented.

In the terminal block according to the present embodiment, the seal member is formed in the tapered shape in which the end face facing the side surface of the recess is inclined to be gradually separated from the side surface toward the bottom surface side of the recess in the axial direction and is configured such that the gap between the end face and the side surface gradually increases toward the bottom surface side in the free state in which the seal member is not compressed between the housing and the attachment target object. With this configuration, in the terminal block, for example, a contact area of the contact surface with the attachment target object can be ensured by the seal member having the tapered shape and assemblability (insertability) to the recess of the housing can be improved. As a result, the terminal block achieves an effect that it is possible to ensure both of assemblability of the seal member to the housing and a water stop property.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar extending in an axial direction;
a housing that holds the bus bar; and
an annular seal member that is assembled to one end face of the housing in the axial direction and performs water stop between the housing and an attachment target object, wherein
on the one end face of the housing, an annular recess that is recessed toward a side opposite to the attachment target object in the axial direction and houses the seal member is provided, and
the seal member is formed in a tapered shape in which an end face facing a side surface of the recess is inclined to be gradually separated from the side surface toward a bottom surface side of the recess in the axial direction and is configured such that a gap between the end face and the side surface gradually increases toward the bottom surface side in a free state in which the seal member is not compressed between the housing and the attachment target object.

2. The terminal block according to claim 1, wherein
the end face includes: an outer side end face facing the side surface on an annular outer circumference side of the recess; and an inner side end face facing the side surface on an annular inner circumference side of the recess, and
the seal member is formed in a tapered shape in which each of the outer side end face and the inner side end face is inclined to be gradually separated from the side surface toward the bottom surface side in the axial direction and is configured such that each of the gap between the outer side end face and the side surface and the gap between the inner side end face and the side surface gradually increases toward the bottom surface side in a free state in which the seal member is not compressed between the housing and the attachment target object.
